(19) United States
(12) Patent Application Publication
(10) Pub. No.: US 2008/0288268 A1
(43) Pub. Date: Nov. 20, 2008

(54) Novel real estate transactions

(76) Inventor: Sanford B. Weiss, Los Angeles, CA (US)

Correspondence Address: STETINA BRUNDA GARRED & BRUCKER, 75 ENTERPRISE, SUITE 250, ALISO VIEJO, CA, 92656, US

(21) Appl. No.: 11/803,360

(22) Filed: May 14, 2007

(51) Int. Cl. G06Q 10/00

(52) U.S. Cl. 705/1

(57) ABSTRACT

Described herein is a method for conducting real estate transactions wherein the sheltering and care of an individual is ensured for the remainder of the individual's life. The method includes the offering of a residence unit for sale by a provider, the purchase of the residence unit for a fixed price by an individual, the individual living in the residence unit and receiving required care from the provider for the remainder of his or her life, and the return of the residence unit to the provider in exchange for a payment made to the resident's estate. Various types of residence units and care may be provided and the financial terms of the method may be structured in various ways.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Field of the Invention

The present invention relates to novel real estate transactions. More particularly, the present invention relates to real estate transactions involving the purchase of a residence by an elderly person, wherein for an initial fixed price the purchaser is guaranteed the residence for the remainder of his or her life at which point ownership of the residence reverts to the seller and all or a portion of the purchase price refunded to the purchaser's estate.

2. Description of Related Art

As the baby boom generation continues aging, the proportion of retired people is steadily increasing. Additionally, the average person is living longer while pension programs are shrinking or disappearing outright and the social security program is at risk. As such, a greater financial burden is falling on individuals during retirement. A major concern for many retirees is that they will outlive their money. As disclosed by the United States Social Security Administration, the average social security benefit for retired workers in January 2007 was $1,046.50 per month. Further, a recent study has shown that the average monthly income from all sources for a retiree is $4,243 per month (an annual average of $50,916).

Although many retirees desire to live on their own for the remainder of their lives, the fact is most people will require at least some assistance as they age. There are numerous communities that provide various degrees of assistance to the elderly. These communities include Independent Living Communities (ILCs) or retirement homes, Assisted Living Communities (ALCs), and Nursing Care Facilities (NCFs) or nursing homes.

ILCs are for retirees who are still relatively active and in good health. Typically, each person or couple has an individual home, apartment, or room. The ILC provides additional facilities for meals, gathering, and recreation. For example, many ILCs have organized social events, trips, tennis courts, swimming pools, common rooms and other amenities. Further, most ILCs are fully secured, allowing residents to leave for extended periods of time knowing that their unit will be safe. Although ILCs typically do not offer health care, they are usually affiliated with health care facilities for when healthcare is needed by residents.

ALCs are for retirees that require assistance with daily activities. Such assistance may include, providing meals, housekeeping, and assistance with bathing, toileting, dressing, walking, and the administration of medications. Unlike ILCs, ALCs provide health care services to its residents. The level of care provided by ALCs, however, is below the continuous nursing care provided by NCFs. ALCs can range from small residential houses with only two or three residents up to large institutional facilities housing hundreds of residents. The common factor is that residents of ALCs have their own private or semi-private residence centered around common areas so that residents may receive the daily assistance they require. The benefits of ALCs include the fact that residents do not need to worry about meal preparation and the social interactions achieved by the common areas reduce the isolation experienced by many elderly people who rarely leave their homes.

NCFs are for retirees who require constant nursing care but do not need to be hospitalized. The basic rate for an NCF usually covers the rent for a room, housekeeping, meals, general nursing care, assistance with daily living activities and recreation. However, many services are not covered by the basic rate, such as, extra nursing services, pharmaceutical needs, telephone service, physical therapy, etc.

Statistics show that one third of men who live beyond 65 will require nursing-home care and one half of women will. Currently the average nursing home in the United States charges $54,900 per year and it is estimated that this cost will rise to $190,000 by the year 2030, when the youngest baby boomers reach age 65. As the average life expectancy when entering a nursing home is 7.5 years, it can be seen that the expense of moving to a nursing home may be prohibitive for the average retiree and will become even more difficult in the future. Although government programs will assist in the cost of a nursing home the stability of these programs are at risk. Further, Medicare will only cover short periods of nursing home care after a hospital stay and Medicaid requires meeting stringent income levels.

One attempted solution to this problem is the idea of Continuing Care Retirement Communities (CCRCs). A typical CCRC provides shelter, residential services, amenities, and a specified amount of nursing care. The benefits of CCRCs include the guarantee of lifetime shelter and specific healthcare treatments. Potential downsides to CCRCs, however, include the fact that a lump-sum initial payment is required, as well as a defined monthly payment. Although the monthly payment may be lower than in a typical nursing home situation due to the initial payment, this method still does not eliminate the risk of a retiree running out of money before the end of his or her life. Additionally, CCRCs usually establish minimum entrance requirements based on age, financial assets, income, and current health. The potential resident must be able to show a sufficient income level in order to gain entrance because CCRCs still require monthly payments for the remainder of the resident's life.

As such, there is a need for a solution wherein a retiree facing the need of a nursing home will be guaranteed shelter and care for the remainder of his or her life regardless of continuing income levels.

### BRIEF SUMMARY

The present invention is directed toward methods involving novel real estate transactions wherein an individual retiree can ensure shelter and care for the remainder of his or her life without concern over continuing income levels. The methods of the present invention are also operative to provide immediate income to a shelter and care provider for use in an investment plan by selling a residence to an individual wherein the provider also regains ownership of the residence upon the death of the individual.

One embodiment of the present invention envisions a method for conducting real estate transactions wherein the sheltering and care of an individual is ensured for the remainder of the individual's life. The method comprises the first step of a provider offering a residence unit for sale. The individual desiring shelter and care then purchases the residence unit for a fixed price and lives in the residence unit while receiving required care from the provider. Upon the individual's death, the individual's estate returns the residence to the provider and receives a payment from the provider in return. The residence unit may be a detached single-family home, a condominium unit, or an individual room or suite of rooms within a larger dwelling.

The payment made by the provider to the individual's estate after the individual's death may be the price paid by the individual for the purchase of the residence unit. The payment may also include an amount equal to the rate of inflation of the initial purchase price.

The required care provided by the provider may include meals, assistance with daily activities, and skilled nursing care.

The method may further include a step wherein the provider obtains insurance against the decrease in value of the residence unit during the individual's lifetime.

The method may also further include a step wherein the provider invests the purchase price of the residence unit in any investment vehicle including, but not limited to stocks, bonds, CDs, additional real estate, and mutual funds.

The method may additionally include a step wherein after receiving the returned residence upon the individual's death, the provider offers the residence unit for sale to a new individual.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flowchart illustrating certain real estate transactions involved in an embodiment of the present invention.

### DETAILED DESCRIPTION

The detailed description set forth below is intended as a description of the presently preferred embodiment of the invention, and is not intended to represent the only form in which the present invention may be utilized. The description sets forth the functions and sequences of steps for operating the invention. It is to be understood, however, that the same or equivalent functions and sequences may be accomplished by different embodiments and that they are also intended to be encompassed within the scope of the invention.

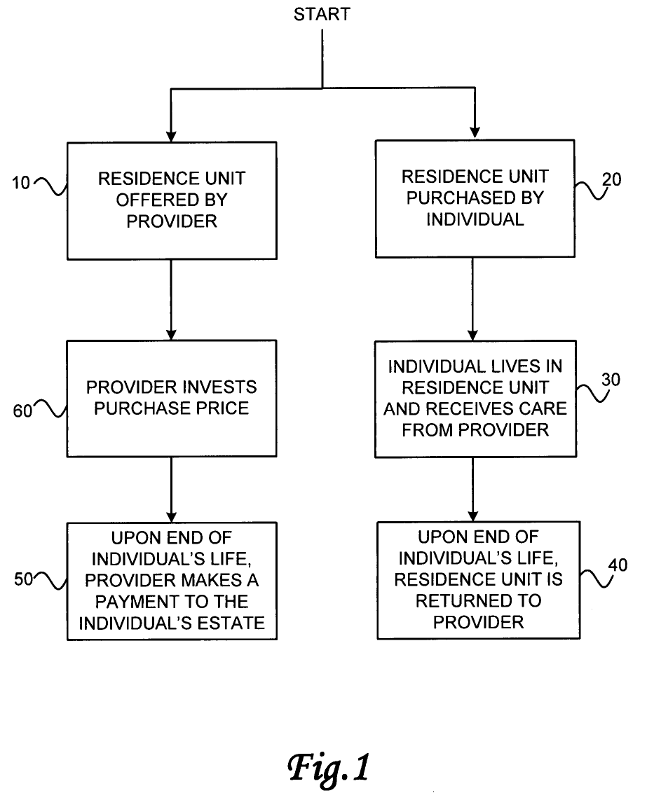

One embodiment of the present invention is presented in the flowchart shown in FIG. 1. This embodiment envisions a method for conducting real estate transactions wherein the sheltering and care of an individual is ensured for the remainder of the individual's life. The method is initiated by a provider offering a residence unit for sale in step 10. The residence unit is usually centered around, or in close proximity to, central gathering areas. These central gathering areas allow for socializing between residents and for the provision of care, such as, for example, physical therapy. The provider typically offers shelter, routine care, and amenities to residents.

The shelter may come in various forms of residence units. One form of residence unit may be a detached single-family dwelling wherein the resident, or a resident and his or her partner, lives in their own enclosure but has a central gathering area in close proximity for socialization and care reasons. It is to be taken that all of the residence units described herein may house either a single resident or a resident and his or her partner, and that all mentions herein of a “resident” also encompasses a resident and his or her partner. Another form of residence unit is a condominium unit, wherein the resident's living space may be attached to other residents' living spaces, but each resident has an individual entrance to his or her own residence unit. Yet another form of residence is an individual room or suite of rooms within a larger dwelling, wherein multiple residence units are located within a single building having a single entrance main entrance for all residents and personal entrances located within the building to each individual resident's unit. In this embodiment, the central gathering area may be located directly within the larger building instead of within a close proximity as described for the previous residence forms.

It is envisioned that residents may move through these various residence units as the requisite amount of daily care increases during a resident's lifetime. For example, a typical resident may start out in a single-family detached dwelling while they are still in a relatively good condition. As time goes on and the resident requires greater supervision and help with daily activities they may be moved to a condominium unit and when a resident requires the greatest amount of care and help with daily activities they may again be moved into an individual room located within a larger dwelling with at least one full-time caregiver also living within the dwelling in a separate residence unit.

The routine care offered to residents may include, but is not limited to, physical therapy, skilled nursing care, and assistance with bathing, toileting, dressing, walking, and the administration of medications. It is to be noted that the amount of care offered to an individual will be described and known in advance at the time of purchasing a residence unit. For example, a particular residence may offer nursing care comparable to an Assisted Living Community (ALC), but not a Nursing Care Facility (NCF), in which case a resident needing care comparable to an NCF would have to be transferred to such a facility. Additionally, the agreement between the provider and the resident may be structured so that if the care required by the resident does indeed rise to the level comparable to an NCF, the payment made to the resident's estate, as will be more fully described below, will be reduced. Additionally, the agreement between the provider and the resident may be structured such that if the care required by the resident rises to a certain level, for example, comparable to that of an NCF or full-time hospitalization, the residence unit is returned to the provider and the provider makes the predetermined payment to the resident and/or his or her legal guardian at that time, instead of upon the resident's death. In this embodiment, the resident may then be transferred to an NCF or hospital independent of the provider's care. It is to be understood that any reference herein to a payment made to the resident's estate upon the resident's death may alternatively be a payment to the resident or the resident's legal guardian upon a decrease in the resident's health requiring the transfer of the resident to a location with care exceeding that offered by the provider. At the time of any payment to the resident, the resident's legal guardian, and/or the resident's estate, possession and title of the residence unit is returned to the provider.

The amenities offered to resident may include, but are not limited to meals, recreation facilities, residence cleaning and maintenance, grounds maintenance, and transportation. In particular, meals provided to residents may include pre-made and structured plans wherein the residents are provided with nutritionally maximized meals tailored to each individual's nutritional requirements. The meals may also be ordered by the residents in a “restaurant” style setting, where the resident would choose meals from a daily menu of items. Additionally, or alternatively, the central gathering areas may include kitchen areas allowing residents to prepare their own meals in a supervised setting. Additionally, the detached home and condominium residence units described above may include their own kitchen areas where residents may prepare their own meals. The recreational facilities provided may include, but are not limited to, gymnasiums for exercise, pools, spas, saunas, clubrooms, ballrooms, game facilities such as, tennis courts, shuffleboard courts, table tennis, pool tables, etc. The provider may also offer planned social activities including, but not limited to, card nights, church meetings, arts and crafts sessions, bingo, daytrips and longer planned vacations, dances, entertainers, etc.

After a residence unit is offered for sale by a provider, step 20 requires an individual to purchase the residence unit for a fixed price. Although this disclosure recites an individual in the singular, it is to be understood that this method applies equally to a couple purchasing and residing in a residence unit. The fixed price may be any price set by the provider and agreed to by the purchaser; although in the usual circumstance the fixed price will be the market price of the residence unit. If it is a couple purchasing the residence unit, instead of a single individual, the purchase price may be increased to take into account the increased costs that will be imposed on the provider due to providing care and amenities to two people. Although, a couple will usually require a larger residence unit that a single individual, and the higher market price of the larger lodging may be the only increase required by the provider.

When this initial purchase price is made, a full disclosure contract will be made between the provider and the resident. This contract will describe, among other things, the purchase price paid by the resident to the provider, the amount of care and amenities that will be provided to the resident during his or her lifetime, the level of nursing care offered by the provider, the relevant situations that will necessitate moving the resident from one type of residence unit to another, and the payment that will be made to the resident's estate upon his or her death or to the resident or his or her legal guardian upon a health decrease requiring transfer to an independent location. The contract will also describe any adjustments to the payment that may be made, such as if the payment amount will be equal to the initial purchase amount, what rate of inflation will be used to increase the payment amount if any such increase is contemplated, if the payment will be decreased in the resident requires nursing care above a certain level, and what that decrease in payment will be.

Upon the purchase of a residence unit, step 30 envisions the individual living in the residence unit and receiving all required care from the provider for the remainder of the individual's life. As discussed more fully above, a variety of care and amenities may be provided to the resident during his lifetime. It is envisioned that the level of amenities may vary considerably between different providers depending on the requirements of residents and the purchase price of the residence units. Although a certain minimal level of care will be provided in all situations, including the providing of meals, assistance with daily activities, providing a central gathering area for socialization between residents, and a certain level of required nursing care. It is assumed that the minimum level of care provided will meet or exceed the level of care required by applicable laws and regulations for assisted living facilities and will meet a certain minimum level of habitability as required by applicable laws and regulations and as may optionally be supplemented in the full disclosure contract agreed to between the provider and the resident. It is further assumed that the facility will meet all licensing requirements for assisted living facilities as required by local, state, and/or federal government requirements.

Upon the death of the resident, the individual's estate returns the residence to the provider in step 40. It is to be understood that the residence unit is not the property of the individual's estate nor is it transferable by the individual's estate other than back to the provider. At this point, the provider may do as she wishes with the residence unit, including offering the unit for sale to other potential residents. However, all of the individual resident's personal belongings are the property of the individual's estate and the provider has no claim to these items.

In exchange for returning the residence unit to the provider, the provider makes a payment to the individual's estate in step 50. It is to be noted, however, that the return of the unit to the provider and the payment to the individual resident's estate is normally not negotiable and must be carried out as indicated in the purchase contract. Although the payment made to the individual resident's estate may be the fixed purchase price initially paid by the resident to the provider, the payment amount may also be another figure. For example, the payment made to the individual resident's estate may be a figure decided on and agreed to in the initial purchase contract. The payment may also be an adjusted figure depending on the situation. For example, the payment may be the fixed purchase price plus an amount equal to the rate of inflation during the resident's stay in the residence unit. The payment may also be decreased from the purchase price, for example, if the resident required nursing care comparable to an NCF facility.

It can be seen that the value of real estate may decrease during the individual resident's lifetime so that upon the resident's death the value of the home is less than the amount owed to the resident's estate. In order to safeguard against this possibility, the provider may optionally obtain insurance against this decrease in value so that the provider is not financially burdened in such a situation. Also, upon receiving the initial purchase price from the individual resident, the provider may, in optional step 60, invest the purchase price in any of numerous investment vehicles. These investment vehicles may include, but are not limited to, stocks, bonds, CDs, additional real estate, mutual funds, money market accounts, and the like. The investment vehicle may be, or include, investment in T-bills or other relatively safe, guaranteed investments in order to ensure that the principal amount invested will be available to return to the resident's estate. Additionally, or alternatively, the purchase price may be placed into a trust or other legal device in order to ensure the safety of the funds and to help guarantee that at least the agreed upon amount will be returned to the resident's estate upon the death of the resident. Another option is that a letter of credit will be issued with the resident as the beneficiary, thereby allowing the resident's estate to claim the funds upon the resident's death or the funds may be placed into an escrow account with instructions that the funds be disbursed to the resident's estate upon the death of the resident and the return of the residence to the provider.

The method of the present invention envisions a beneficial situation for all parties involved. Particularly, the individual resident receives the security in knowing that his or her safety and wellbeing will be provided for the remainder of his or her life without consideration to future income levels. The provider receives an initial purchase price which may then be invested during the resident's stay to provide a steady income and/or increase in capital during this period. Upon the resident's death, the provider receives the residence unit back at which point he or she may then offer the unit for sale again, following this process indefinitely for a continuous supply of capital. Further, the resident's estate receives the benefit of receiving a payment from the provider in exchange for the returning of the residence unit. As can be seen the above recited invention allows for novel, beneficial real estate transactions wherein an individual's shelter and care is provided for the remainder of his or her life, the provider receives a source of capital, and the individual's estate receives a payment.

The above description is given by way of example, and not limitation. Given the above disclosure, one skilled in the art could devise variations that are within the scope and spirit of the invention disclosed herein, including various ways of structuring the initial payment price, the level of care provided during the resident's lifetime, and the structuring of the payment to the resident's estate. Additionally, the form of the transaction may occur in a variety of forms depending on the desire of the parties. The forms of the transaction may have differing tax consequences to the involved parties and the form of the transaction may be structured to optimize the tax consequences to one or both parties involved. For example, rather than purchasing the residence unit and taking title, the resident may instead obtain a fully prepaid lease with a term extending until the death of the resident. Alternatively, as discussed above, the resident may purchase the residence unit outright and take title to the residence with an agreement to sell the residence unit back to the provider upon the death of the resident. Further, as previously discussed, the residence unit may be held in trust for the benefit of the resident, wherein upon the death of the resident the succeeding beneficiary of the residence unit is the provider. As can be seen, the form of the transfer of the residence unit may occur in a multitude of forms and is not intended to be limited by the embodiments described herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for conducting real estate transactions wherein the sheltering and care of an individual is ensured for the remainder of the individual's life, the method comprising the steps:
a. a provider offering a residence unit for sale;
b. the individual purchasing the residence unit for a fixed price;
c. the individual living in the residence unit and receiving required care from the provider;
d. the individual's estate returning the residence to the provider upon the individual's death;
e. the provider making a payment to the individual's estate.

2. The method of claim 1 wherein the residence unit is a detached single-family dwelling.

3. The method of claim 1 wherein the residence unit is a condominium unit.

4. The method of claim 1 wherein the residence unit is an individual room or suite of rooms located within a larger dwelling.

5. The method of claim 1 wherein the payment to the individual's estate made in step (e) comprises the fixed purchase price of step (b).

6. The method of claim 1 wherein the payment to the individual's estate made in step (e) comprises the fixed purchase price of step (b) as well as an amount equal to the rate of inflation of the fixed purchase price.

7. The method of claim 1 wherein the required care of step (c) comprises providing meals.

8. The method of claim 1 wherein the required care of step (c) comprises providing assistance with daily activities.

9. The method of claim 1 wherein the required care of step (c) comprises providing skilled nursing care.

10. The method of claim 1 further comprising a step wherein the provider obtains insurance against the decrease in value of the residence unit.

11. The method of claim 1 further comprising a step wherein the provider invests the purchase price received in step (b).

12. The method of claim 1 further comprising a step wherein after receiving the returned residence in step (d), the provider offers the residence unit for sale to a new individual.
